(19) United States
(12) Patent Application Publication
(10) Pub. No.: US 2016/0314701 A1
(43) Pub. Date: Oct. 27, 2016

(54) METHOD AND SYSTEM FOR MANAGING A WORDGRAPH

(71) Applicant: TWINWORD INC., Anyang-si, Gyeonggi-do (KR)

(72) Inventor: Kun Oh KIM, Anyang-si, Gyeonggi-do (KR)

(73) Assignee: TWINWORD INC., Gyeonggi-do (KR)

(21) Appl. No.: 15/104,240

(22) PCT Filed: Dec. 19, 2013
(86) PCT No.: PCT/KR2013/011866

§ 371 Date: Jun. 14, 2016

(51) Int. Cl. G09B 7/06; G09B 19/06

(52) U.S. Cl. CPC G09B 7/06; G09B 19/06

(57) ABSTRACT

Method and system for managing a wordgraph is provided. The present invention include a method and a system for managing a word graph, wherein the method includes receiving, by a management server, a result of vocabulary level test from a client device, extracting a correct answer rate or an incorrect answer rate for each word pair by analyzing the received result of vocabulary level test, calculating a meaning distance of word pair in response to the extracted correct answer rate or incorrect answer rate, and updating a pre-stored word graph, or generating a new word graph using the calculated meaning distance.

### TECHNICAL FIELD

The teachings in accordance with exemplary embodiments of this invention relate generally to a method for managing a word graph and a system thereof

### BACKGROUND ART

Word graph may be a type of thesaurus that records relationships of meanings among words, and may be a data in which relatively similar words are recorded at a close distance, and words having dissimilar meaning are recorded at a long distance, and may be further termed as word map.

One of the most representatively known word graphs may be a word net made by Cognitive Science Research Institute of Princeton University and OpenCyc by Artificial Intelligent Project Cyc. The thesaurus, a reference book in which words with similar meanings are grouped together, may be called a type of word graphs. In other words, the word graph is an online thesaurus that helps find meanings of words and show connections among associated words by way of relationships and distances, whereby a computer is enabled to perform a function of beneficial knowledge base during artificial intelligence-related algorithm process.

For example, in a reply to a question of “What are you going to have for a drink?” in a conversation, the reply would be outputted using a word graph stored with information such as colas, soda pops and juices. As evidenced in the above case, the word graph is a type of knowledge base, and its functional importance keeps growing day by day.

However, the word graph suffers from disadvantages that it is difficult to set up, and it also takes lots of time and efforts to maintain and update as in the initial set-up due to language characteristics that change in time. Another disadvantage is that requirements to set up and update a word graph that is reflected with geographical characteristics cannot be satisfied, in light of the fact that a language changes differently according to geographical regions.

### DISCLOSURE OF INVENTION

### Technical Problem

Accordingly, the present invention has been made keeping in mind with the above disadvantages or problems occurring in the prior art, and an object of the present invention is to provide a method for managing a word graph configured to automatically maintain and repair the word graph by enabling set-up and update of the word graph reflected with a user concept of association words through interaction with general users, and a system thereof.

Another object is to provide a method for managing a word graph configured to ease generation and update of regional word graphs, and a method thereof.

### Solution to Problem

An object of the invention is to solve at least one or more of the above problems and/or disadvantages in whole or in part and to provide at least the advantages described hereinafter. In order to achieve at least the above objects, in whole or in part, and in accordance with the purposes of the invention, as embodied and broadly described, and in one general aspect of the present invention, there is provided a method for managing a word graph, the method comprising: receiving, by a management server, a result of vocabulary level test from a client device; extracting a correct answer rate or an incorrect answer rate for each word pair by analyzing the received result of vocabulary level test; calculating a meaning distance of word pair in response to the extracted correct answer rate or incorrect answer rate; and updating a pre-stored word graph, or generating a new word graph using the calculated meaning distance.

Preferably, but not necessarily, the vocabulary level test may be performed on the client device based on the word graph pre-stored in the management server and received by the management server.

Preferably, but not necessarily, the method may further comprise calculating regional meaning-related information and distance based on the calculated meaning distance.

Preferably, but not necessarily, the method may further comprise generating at least one regional word graph based on the calculated regional meaning-related information and distance.

Preferably, but not necessarily, the method may further comprise providing the at least one regional word graph to a regional advertising server.

Preferably, but not necessarily, the calculating the meaning distance may be performed by providing a larger weight to the meaning distance with a higher correct answer rate and a smaller weight to the meaning distance with a lower incorrect answer rate.

In another general aspect of the present invention, there is provided a system for managing a word graph, the system comprising: a memory configured to store a word graph; a setting unit configured to set a vocabulary level test based on the word graph stored in the memory; an input/output unit configured to provide the vocabulary level test to a client device and receive a result of the vocabulary level test performed by the client device; an analysis unit configured to analyze a correct answer rate or an incorrect answer rate for each word pair by analyzing the received test result of the vocabulary level test; a first calculation unit configured to calculate a meaning distance of the word pair in response to an extracted correct answer rate or incorrect answer rate; and an update unit configured to update the stored word graph or to generate a new word graph using the calculated meaning distance.

Preferably, but not necessarily, the system may further comprise a second calculation unit configured to calculate regional meaning-related information and distance based on the calculated meaning distance.

Preferably, but not necessarily, the system may further comprise a generating unit configured to generate at least one regional word graph based on the calculated regional meaning-related information and distance.

Preferably, but not necessarily, the input/output unit may provide the at least one regional word graph to a regional advertisement server.

Preferably, but not necessarily, the update unit may automatically update the word graph when the incorrect answer rate extraction or meaning distance calculation is performed more than a predetermined number.

Preferably, but not necessarily, the first calculation unit may perform calculation by providing a larger weight to the meaning distance with a higher correct answer rate and a smaller weight to the meaning distance with a lower incorrect answer rate.

### Advantageous Effects of Invention

The method and system for managing a word graph according to the present invention has an advantageous effect in that a word graph can be automatically set up and updated by collecting and analyzing information including a vocabulary level test through interaction with general users to help reduce efforts by a manager, and the set word graph can be utilized to various systems related to human languages including search engines, advertising platforms and question/answer systems.

Another advantageous effect is that language characteristics that continuously change in time can be reflected on word graphs by collection and analysis of information through interaction with users of various regions, and set-up and update of word graphs that regionally change in time can be implemented at a low cost through generation of various word graphs.

Still another advantageous effect is that questions for vocabulary level tests can be easily generated by using word graphs managed by the present invention, and vocabulary levels can be accurately measured for each user.

### BRIEF DESCRIPTION OF DRAWINGS

The teachings of the present invention can be readily understood by considering the following detailed description in conjunction with the accompanying drawings, in which:

FIG. 1 is a schematic view illustrating a configuration of a system for managing a word graph according to an exemplary embodiment of the present invention;

FIG. 2 is a schematic block diagram illustrating constituent elements of a word graph management server according to an exemplary embodiment of the present invention;

FIG. 3 is a block diagram illustrating a method for managing a word graph according to a first exemplary embodiment of the present invention;

FIG. 4 is a block diagram illustrating a method for managing a word graph according to a second exemplary embodiment of the present invention;

FIG. 5 is a schematic view illustrating a display of vocabulary level test for an association word according to an exemplary embodiment of the present invention;

FIG. 6 is a schematic view illustrating a screen for extraction of statistics from vocabulary level test for association word according to an exemplary embodiment of the present invention; and

FIG. 7 is a schematic view illustrating a part of word graph according to an exemplary embodiment of the present invention.

### BEST MODE FOR CARRYING OUT THE INVENTION

The following description is not intended to limit the invention to the form disclosed herein. Consequently, variations and modifications commensurate with the following teachings, and skill and knowledge of the relevant art are within the scope of the present invention. The embodiments described herein are further intended to explain modes known of practicing the invention and to enable others skilled in the art to utilize the invention in such, or other embodiments and with various modifications required by the particular application(s) or use(s) of the present invention.

Hereinafter, a method and a system for managing a word graph (hereinafter referred to as word graph managing method and system) according to exemplary embodiments of the present invention will be described with reference to the accompanying drawings.

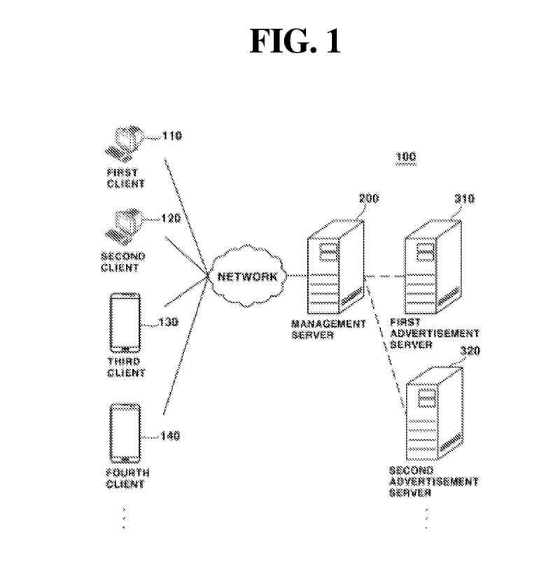

FIG. 1 is a schematic view illustrating a configuration of a system for managing a word graph according to an exemplary embodiment of the present invention.

Referring to FIG. 1, a management server (200) for managing a word graph may be connected to a plurality of client devices (110 to 140) through a communication network, and in some cases may be connected to advertisement servers (310, 320).

The client devices (110 to 140) are devices configured to execute an associated vocabulary level test program according to a word graph by being connected to the management server (200) through a communication network, and may be computing devices such as personal computers, a PDAs (Personal Digital Assistances), tablet computers, net-books and smart phones. The client devices (110 to 140) may be connected to the management server (200) through various data communications including 3G, LTE (Long Term Evolution) and Wi-Fi (Wireless Fidelity) to execute a vocabulary level test provided by the management server (200).

For example, the client devices (110 to 140) may receive result information by performing the vocabulary level test in real time while being connected to the management server (200) or transmit the result information, or may perform the vocabulary level test using a program (e.g., application of smart phone) stored in the client devices (110 to 140), or may receive the result information in response to a user selection after a predetermined period of time and after completion of a predetermined test and transmit the result information.

As noted from the foregoing, the present invention can provide interactable information such as a vocabulary level test to a user (general public) of the client devices (110 to 140), and set up a word graph reflected with recognition (i.e., linguistic knowledge to associated language) of users by collecting and analyzing the feedback result information.

The management server (200) can receive a result of the vocabulary level test from the client devices (110 to 140), and analyze the result, and provide to the client devices (110 to 140) a result (i.e., result level, question solution, etc.) based on the analysis, and calculate a meaning distance between association words using analysis contents. The management server (200) can analyze the result information received from the client devices (110 to 140) to extract statistics, and update the existing word graph using the extracted statistics. That is, the word graph is updated using the feedback information (i.e., result information of vocabulary level test) collected by the management server (200) from the client devices, whereby automatic update of word graph can be implemented using a relationship between the result of vocabulary level test and association word.

In some exemplary embodiments, the management server (200) may be associated with advertisement servers (310, 320). The management server (200) can provide a part or all of the word graph information to the advertisement servers and updating the word graph based on the statistics obtained by analyzing the result information of the vocabulary level test whereby advertisements based on the associated language is enabled. Particularly, the management server (200) can provide associated language-based advertisement to each region. For example, ‘chicken’ and ‘beer’ may be in an associated language relation in Korea, and when a word of ‘chicken’ is entered into a particular web blog or a website, a ‘beer’ advertisement' can be inserted. As noted from the foregoing, a customized advertisement or a customer-oriented advertisement can be provided through association between the management server (200) and at least one of the advertisement servers (310, 320).

The existing word graph has had no consideration for a region, and has been set up based on general (common) associated relation only. However, the present invention can set up the word graph in consideration of regional meaning to the association words to enable enhancement of use of the word graphs.

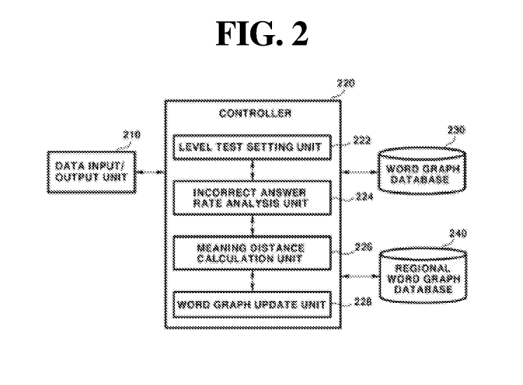

FIG. 2 is a schematic block diagram illustrating constituent elements of a word graph management server according to an exemplary embodiment of the present invention.

The word graph management server (200) according to the present invention is a server-functionable computer for maintaining and repairing word graphs analyzing vocabulary level test and using the analyzed vocabulary level test. The word graph management server (200) according to the present invention may include a data input/output unit (210) configured to receive data from other devices and transmit the data to other devices, a controller (220) configured to analyze the received data and to control constituent elements, a word graph database (230) configured to store generated word graphs and a regional word graph database (240) configured to store at least one word graph generated from each region. The word graph management server (200) according to the present invention may include other constituent elements for performing the functions of the present invention but detailed explanation thereto is omitted herefrom.

In order for the management server (210) to interact with the other devices, the data input/output unit (210) may receive/output data to transmit the data to other devices. For example, when the client device (110) requests for performance of vocabulary level test, and data input/output unit (210) may receive the request data, transmit the request data to the controller (220) and output a data for performing the vocabulary level test to the client device (110). That is, the vocabulary level test is provided to a user for the purpose of fun and information supply, and at the same time, for the purpose of collecting information necessary for word graph. Thus, the automatic information collection can be implemented by providing the vocabulary level test to the client device and by collecting result information corresponding thereto selectively inputted by a user.

The controller (220), which is a kind of processor, functions to maintain, repair or update the existing word graph stored in the word graph database (230) by analyzing and processing information received from the data input/output unit (210), or to generate a new word graph. The controller (210) may include a vocabulary level test setting unit (222) for realizing the functions of the present invention, an incorrect answer rate analysis unit (224), a meaning distance calculation unit (226) and a word graph update unit (228).

The vocabulary level test setting unit (222) may set a vocabulary level test questions (i.e., quizzes) for each level by using a word graph stored in the word graph database (230), a method of which may be that the questions are generated or set in real time whenever there is a request from the client devices (110 to 140), or pre-stored questions (e.g., pre-stored questions by updating for each particular period) may be outputted. Alternatively, the vocabulary level test questions may be updated together whenever the word graph database (230) is updated.

Levels of questions set by the vocabulary level test setting unit (222) are designated based on a meaning distance between associated words, where a principle of cognitive psychology is used in which an incorrect answer rate is high when a meaning distance is short, and an incorrect answer rate is low when a meaning distance is long. The principle is simple. For example, when questions (‘tail’, ‘animal’, ‘lion’) are provided to a user and the user is requested to selectively input a correct answer between ‘dog’ and ‘sheep’, the user may be confused, but when a user is requested to selectively input a correct answer, the user can easily select ‘dog’. This is a cognitive psychological reaction that is generated by a short meaning distance between ‘dog’ and ‘sheep’ and by a long meaning distance between ‘dog’ and ‘computer’ . Hence, words in short meaning distance may be suggested and set as item selections for higher levels, using the principle of cognitive psychology.

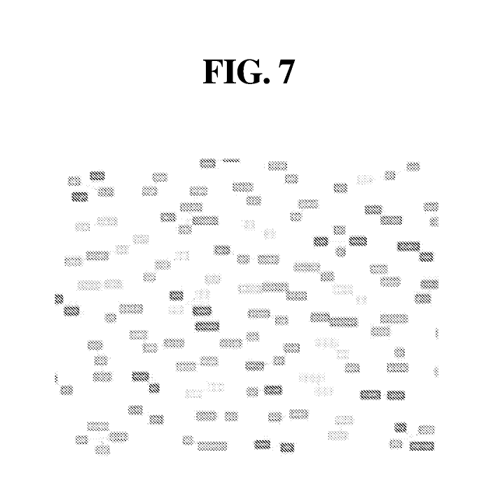

The ‘meaning distance’ is a physical distance based on similarity in meaning between or among words, and as illustrated in FIG. 7, words may have similarity in meaning with several other words by constituting a word graph in which words are arranged in close distances or long distances. When a vocabulary level test is set based on the meaning distances, the data input/output unit (210) transmits vocabulary level test questions to a client device that has requested the vocabulary level test. When the client devices (110 to 140) inputs correct answers to the questions, a response to the vocabulary level test is transmitted to the management server (200) subsequent to completion of vocabulary level test or completion of each question, for example, and inputted through the data input/output unit (210).

The controller (220) may receive a vocabulary level test result from the data input/output unit (210), and transmit the result to the incorrect answer rate analysis unit (224). The incorrect answer rate analysis unit (224) may analyze the vocabulary level test result and extract an incorrect answer rate or a correct answer rate to each word pair, and may additionally generate the extracted incorrect answer rate as a statistical data At this time, the statistical data may be generated subsequent to collection of results to a certain degree, and a statistical extraction may be such that there is an association word (similar word, related word or synonym) relationship where an incorrect answer rate is high.

For example, when a statistical data is set and generated after collection of more than ten times of results relative to a particular word pair, and when question results relative to the word pair are received more than ten times from same or different client devices, the statistical data relative to incorrect answer rate or correct answer rate may be newly prepared or updated. This is because statistics of meaningful incorrect answer rate can be generated when the question results reach a count or a frequency more than an appropriate level.

Meanwhile, the incorrect answer rate analysis unit (224) may analyze an incorrect answer rate or a correct answer rate and notify a result level to the client devices (100 to 140), and may additionally transmit information such as solution to question to the client devices (110 to 140).

The meaning distance calculation unit (226) may calculate a meaning distance to each word pair by receiving a statistical data from the incorrect answer rate analysis unit (224) relative to the incorrect answer rate or the correct answer rate. As explained above, the calculation is implemented according to a predetermined rule that a meaning distance grows short for a higher incorrect answer rate, based on a statistical result in which an association word relationship is higher for higher incorrect answer rate for each word pair. For example, the calculation may be implemented in such a manner that a value indicating a meaning distance grows larger by applying a higher weight for a lower incorrect answer rate (e.g., percentage) during meaning distance calculation. The meaning distance may differently appear depending on region, age and the like, and a meaning distance calculated for each category may be separately generated and stored by reflecting the abovementioned characteristics.

The calculated meaning distance may be transmitted to the word graph update unit (228) for reflection on the existing word graph, and the word graph update unit (228) may update word graphs stored in the word graph database (230) and/or in the regional word graph database (240). That is, newly generated meaning distances relative to the existing word graph are combined, and the word graph may be maintained, corrected or changed by reflecting the newly calculated meaning distances. The word graph may be stored in the word graph database (230) in a combined format, or the regional word graph database (240) configured to store regionally differently generated word graphs may be additionally prepared. As noted from the foregoing, a large quantity of word graphs can be easily updated by automatically maintaining and repairing the word graph through analysis of incorrect answer rate (correct answer rate) to the vocabulary level test. For example, degree of utilization can be enhanced by generating various word graphs for each category including region.

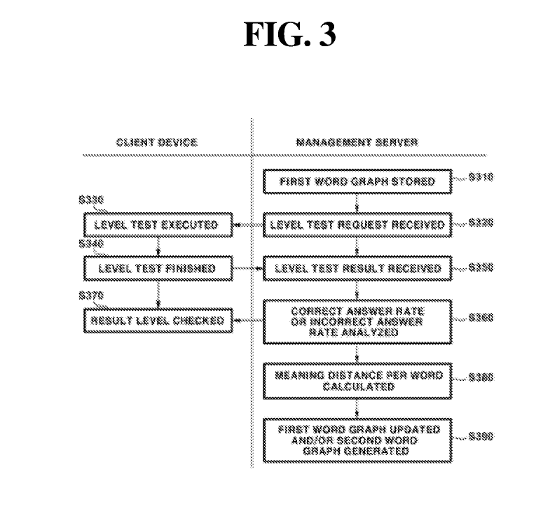

FIG. 3 is a block diagram illustrating a method for managing a word graph according to a first exemplary embodiment of the present invention.

As noted from FIGS. 1 and 2, the method for managing a word graph may be realized by interaction between at least one client device (110 to 140) and a management server (200). For convenience sake, explanation will be given with reference to constituent elements illustrated in FIGS. 1 and 2.

The word graph database (230) of the management server (200) or the regional word graph database (240) is pre-stored with word graphs necessary for vocabulary level test (S313). When a request for implementing a vocabulary level test is received from the client server (S320), a vocabulary level test is set using the pre-stored word graphs. For example, the management server (200) may output an executive command (e.g., an executive command comprised of programming languages) for implementation on the client device, along with the set vocabulary level test questions to allow the set vocabulary level test to be executed on the client devices (110 to 140) (S330).

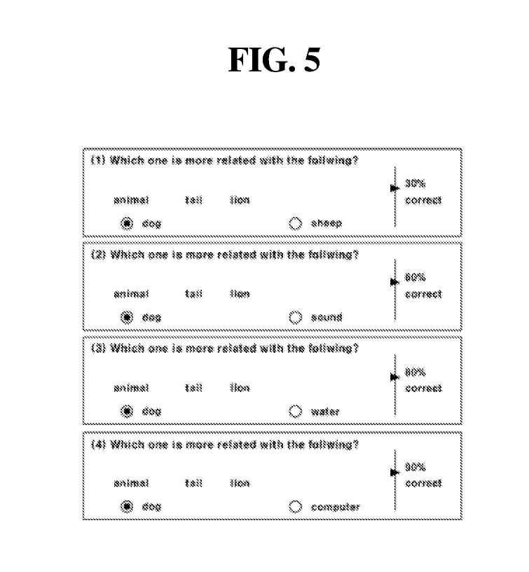

The client devices (110 to 140) execute the vocabulary level test received from the management server (200). For example, in case of the client device being a smart phone, a vocabulary level test may be executed in the form of an application on the smart phone. In case of the client device being a personal computer, the vocabulary level test may be executed on a website operated by the management server (200). When a vocabulary level test is outputted to a display screen, a user may input a correct answer using an input device of the client device, where the inputted (selected) correct answer is result information relative to the vocabulary level test. The method of vocabulary level test thus described will be explained in more detail with reference to FIG. 5.

In some exemplary embodiments, when a vocabulary level test is finished, the client device transmits the inputted correct answer, i.e., a result on the vocabulary level test, to the management server (200) (S340). When the management server (200) receives the result on the vocabulary level test, the inputted data is transmitted to the controller (220) (S350). Hence, the collection of information necessary for update of word graph can be eased by using the result information of the vocabulary level test, and automatic maintenance and repair of the word graphs can be implemented.

The controller (220) of the management server (200) may analyze a correct answer rate or an incorrect answer rate to the result of the vocabulary level test, and calculate a statistical value of the correct answer rate or the incorrect answer rate for each word pair (S360). At this time, in order to extract a meaningful statistical value, the analysis of the correct answer rate or the incorrect answer rate may be implemented when results (i.e., input information of the client device) of the vocabulary level test to a particular word pair are collected for more than a predetermined number (count). For example, when a statistical value is calculated during receipt of results for more than ten times (counts), and when results of ten times are received for a word pair of ‘pencil’ and ‘ballpoint pen’, analysis to the word pair is implemented to newly calculate a statistical value to a correct answer rate and an incorrect answer rate. This calculation is to automatically reflect the information that is changed to the pre-stored word graph, and this rule enables an easy maintenance and repair of the word graph.

Meantime, in addition to the analysis of correct answer rate or incorrect answer rate for calculating the statistical value, the management server (200) may provide a result level of the vocabulary level test to the client devices (100 to 140) by analyzing a result of the vocabulary level test (S370). Furthermore, solutions to each question can be also provided, where the client devices (100 to 140) can check the result levels and solutions, and challenge can be made to next levels automatically or according to selection by a user.

When the step of S350 is implemented, the statistical value to the correct answer rate or incorrect answer rate may be transmitted to the meaning distance calculation unit (226) may calculate a meaning distance between each word pair according to a predetermined rule based on the received statistical value (S380). As noted from the foregoing, a different weight is provided according to incorrect answer rate in order to realize a closer meaning distance on the word graph for higher incorrect answer rate, whereby a meaning distance between words as intended by the present invention can be calculated.

The calculated meaning distance is reflected on the existing word graph (e.g., first word graph of FIG. 3) using a combination method or a correction method to thereby update the word graph (S390). Although particular words have no meaning distances on the existing word graph, and when a newly extracted meaning distance exists, the newly extracted meaning distance is reflected to connect two words using the calculated meaning distance. Furthermore, a different word graph (e.g., second word graph of FIG. 3) may be newly generated and realized depending on fields. Hence, the word graphs can be automatically updated through these processes to quickly and conveniently maintain and repair word graphs having a large amount of data

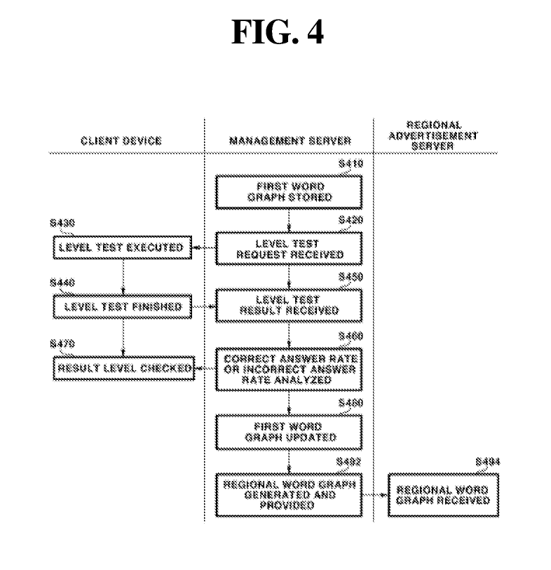

FIG. 4 is a block diagram illustrating a method for managing a word graph according to a second exemplary embodiment of the present invention.

Referring to the second exemplary embodiment illustrated in FIG. 4, the steps of S310 to S390 are commonly implemented, but there are differences (S492, S493) in the second exemplary embodiment illustrated in FIG. 4 in that word graphs are provided to the regional advertising servers (310, 320). In FIG. 4 as explained in FIG. 3, a vocabulary level test is implemented on the client device based on the existing word graph (S410 to S450), and the receive vocabulary level test is analyzed to upgrade the word graph (S450 to S490).

However, positions of the client devices (110 to 140) may be grasped, or position information is received from the client devices (110 to 140) to implement the analysis of correct answer rate or incorrect answer rate for each region. This reflects characteristics in which language properties for each region and meaning relation differently change in time, and is to calculate the meaning distance for each region. The management server (200) may calculate a statistical value for incorrect answer rate relative to a predetermined regional category (e.g., administrative region or state) and calculate a meaning distance for each region (S480).

A regional word graph can be generated (S492) according to calculation of meaning distance for each region, and the pre-stored regional word graph can be also updated (S490). The regional word graphs thus updated or newly generated may be stored in their own self databases (e.g., regional word graph database of FIG. 2). The stored regional word graphs may be provided to the regional advertisement servers (310, 320) during periodic update or according to request from the advertisement server, where the regional advertisement servers use same to provide an advertisement based on the meaning distance.

For example, a closest association word in meaning distance to ‘beer’ may be a ‘sausage’ in Germany, and may be a ‘chicken’ in Korea. Under this circumstance, when a webpage described with a word related to ‘beer’ is displayed in Germany, an advertisement on the ‘sausage’ may be outputted , and when a webpage described with a word related to ‘beer’ is displayed in Korea, an advertisement on the ‘chicken’ may be outputted. The realization of advertisement based on association words can maximize an advertisement effect and can effectively satisfy both advertisers and users alike. The degree of utilization of word graphs can be enhanced by allowing the method for managing the word graph to interact with the advertisement method.

FIGS. 5, 6 and 7 are schematic views illustrating vocabulary level tests and word graphs according to exemplary embodiments of the present invention. FIG. 5 is a schematic view illustrating a display of an associated vocabulary level test according to an exemplary embodiment of the present invention.

Referring to FIG. 5, questions may be set in the manner of more than one word being suggested, and selection being made on association words related thereto. At this time, questions may be set in the manner of the suggested word being identical and only the words in selective items being replaced, and a meaning distance between words in the selective items can be calculated through the incorrect answer rate such as a result of correct answer selected to the identical question. In another exemplary embodiment, an association word that comes up upon view of a suggested word can be directly inputted. Furthermore, a correct answer rate or an incorrect answer rate is displayed adjacent to a question of association word to allow a user solving the question to learn a level (i.e., correct answer rate) of relevant question.

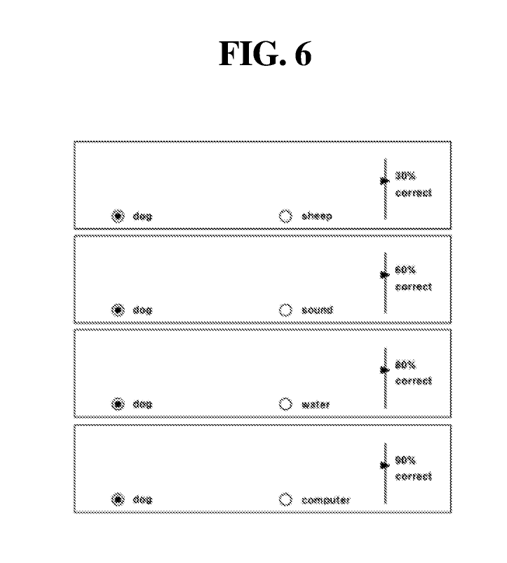

When a vocabulary level test is completed through the method as illustrated in FIG. 5, result information of the vocabulary level test selectively inputted from the client device may be transmitted to the management server (200) as illustrated in FIG. 6.

FIG. 6 is a schematic view illustrating a screen for extraction of statistics from vocabulary level test for association word according to an exemplary embodiment of the present invention, where a percentage thereof is displayed through analysis of correct answer rate or incorrect answer rate for each word pair.

As discussed from the foregoing, more than a predetermined number of results is received through analyses of the incorrect answer rate (or correct answer rate) for each word pair and extracted as a statistical value, and a meaning distance can be calculated using the extracted statistical value. That is, a closest word in meaning distance to ‘dog’ in FIG. 6 is ‘sheep’ and a word of ‘computer’ may be extracted as a longest word in meaning distance.

FIG. 7 is a schematic view illustrating a part of word graph according to an exemplary embodiment of the present invention.

When a meaning distance is calculated from the incorrect answer rate as in FIG. 6, a word graph as in FIG. 7 may be generated based on the meaning distance. That is, association words may be arranged at a position physically far distanced from the word graph in FIG. 7 when values in the meaning distance are calculated in larger numbers, and the association words may be arranged at a relatively closer position when the values in the meaning distance is calculated in small numbers.

Although FIG. 7 illustrates a part of the word graph, the word graph may be a map or a graph of a large size comprised of a large number of words. Thus, although a huge amount of efforts was spent to set up and update the word graphs according to prior art, the set-up and maintenance/repair of word graphs can be quickly and easily implemented through the method according to the present invention. Furthermore, the method and system for managing a word graph according to the present invention enables a word graph to be automatically set up and updated, whereby the present invention can be utilized to various systems related to human languages including search engines, advertising platforms and question/answer systems.

As discussed from the foregoing, the method and system for managing a word graph according to the present invention has an advantageous effect in that a word graph can be automatically set up and updated by collecting and analyzing information including a vocabulary level test through interaction with general users to help reduce efforts by a manager, and the set word graph can be utilized to various systems related to human languages including search engines, advertising platforms and question/answer systems.

Another advantageous effect is that language characteristics that continuously change in time can be reflected on word graphs by collection and analysis of information through interaction with users of various regions, and set-up and update of word graphs that regionally change in time can be implemented at a low cost through generation of various word graphs.

Still another advantageous effect is that questions for vocabulary level tests can be easily generated by using word graphs managed by the present invention, and vocabulary levels can be accurately measured for each user.

As the present invention has been provided to explain in detail the examples to help understand the present invention, it should be apparent that constituent elements, connected relationship thereamong and functions thereof are simply exemplary.

Although the detailed description of the present invention has explained detailed exemplary embodiments, each exemplary embodiment that does not deviate from the scope of the present invention may be changed to various modifications. For example, although the data input/output unit (210), the controller (220) and the databases (230, 240) of management server (200) are separately illustrated, these constituent elements may be embodied in an integral manner in whole or in part, and may be embodied using separate devices.

The previous description of the present invention is provided to enable any person skilled in the art to make or use the invention. Various modifications to the invention will be readily apparent to those skilled in the art, and the generic principles defined herein may be applied to other variations without departing from the spirit or scope of the invention. Thus, the invention is not intended to limit the examples described herein, but is to be accorded the widest scope consistent with the principles and novel features disclosed herein.

### INDUSTRIAL APPLICABILITY

The method and system for managing a word graph according to the present invention has an industrial applicability in that a word graph can be automatically set up and updated by collecting and analyzing information including a vocabulary level test through interaction with general users to help reduce efforts by a manager, and the set word graph can be utilized to various systems related to human languages including search engines, advertising platforms and question/answer systems.

Another industrial applicability is that language characteristics that continuously change in time can be reflected on word graphs by collection and analysis of information through interaction with users of various regions, and set-up and update of word graphs that regionally change in time can be implemented at a low cost through generation of various word graphs.

Still another industrial applicability is that questions for vocabulary level tests can be easily generated by using word graphs managed by the present invention, and vocabulary levels can be accurately measured for each user.

1. A method for managing a word graph, the method comprising: receiving, by a management server, a result of vocabulary level test from a client device; extracting a correct answer rate or an incorrect answer rate for each word pair by analyzing the received result of vocabulary level test; calculating a meaning distance of word pair in response to the extracted correct answer rate or incorrect answer rate; and updating a pre-stored word graph, or generating a new word graph using the calculated meaning distance.

2. The method of claim 1, wherein the vocabulary level test is performed on the client device based on the word graph pre-stored in the management server and received by the management server.

3. The method of claim 1, further comprising: calculating regional meaning-related information and distance based on the calculated meaning distance.

4. The method of claim 3, further comprising: generating at least one regional word graph based on the calculated regional meaning-related information and distance.

5. The method of claim 4, further comprising: Providing the at least one regional word graph to a regional advertisement server.

6. The method of claim 1, wherein the calculating the meaning distance is performed by providing a larger weight to the meaning distance with a higher correct answer rate and a smaller weight to the meaning distance with a lower incorrect answer rate.

7. A system for managing a word graph, the system comprising: a memory configured to store a word graph; a setting unit configured to set a vocabulary level test based on the word graph stored in the memory; an input/output unit configured to provide the vocabulary level test to a client device and receive a result of the vocabulary level test performed by the client device; an analysis unit configured to analyze a correct answer rate or an incorrect answer rate for each word pair by analyzing the received test result of the vocabulary level test; a first calculation unit configured to calculate a meaning distance of the word pair in response to an extracted correct answer rate or incorrect answer rate; and an update unit configured to update the stored word graph or to generate a new word graph using the calculated meaning distance.

8. The system of claim 7, further comprising: a second calculation unit configured to calculate regional meaning-related information and distance based on the calculated meaning distance.

9. The system of claim 8, further comprising: a generating unit configured to generate at least one regional word graph based on the calculated regional meaning-related information and distance.

10. The system of claim 9, wherein the input/output unit provides the at least one regional word graph to a regional advertising server.

11. The system of claim 7, wherein the update unit updates the word graph when the incorrect answer rate extraction or meaning distance calculation is performed more than a predetermined number.

12. The system of claim 7, wherein the first calculation unit performs calculation by providing a larger weight to the meaning distance with a higher correct answer rate and a smaller weight to the meaning distance with a lower incorrect answer rate.
